(19) United States
(12) Patent Application Publication
(10) Pub. No.: US 2007/0214711 A1
(43) Pub. Date: Sep. 20, 2007

(54) Mosquito eradicator

(76) Inventor: Guy Felix Mignot, Durban (ZA)

Correspondence Address: YOUNG & THOMPSON, 745 SOUTH 23RD STREET, 2ND FLOOR, ARLINGTON, VA, 22202, US

(21) Appl. No.: 11/710,548

(22) Filed: Feb. 26, 2007

(30) Foreign Application Priority Data
Feb. 27, 2006 (ZA) 2006/01679

(51) Int. Cl. A01M 1/10

(52) U.S. Cl. 43/107; 43/132.1

(57) ABSTRACT

A mosquito eradication device has a reservoir for water and a breeding chamber that is immersed in the water during egg laying and larva and pupa development, and that is raised during the day to cause decimation of the eggs, larva and pupa.

### FIELD OF THE INVENTION

This invention relates to a device specifically for decimating mosquito eggs, larvae and pupa in town and villages around the world.

### BACKGROUND TO THE INVENTION

Many methods have been considered for the eradication of mosquitoes, but most of these use chemicals that either repel the insects or kill them outright. The application of these is varied, ranging from hand use to a form of crop spraying of large areas to kill the insects, focussing largely on the insect itself.

Another form of eradication is to locate breeding areas and destroy the mosquitoes' eggs, larvae and pupa en masse. This form is preferred as it involves the eradication of a very large number of the young at once, but it is an expensive method.

For this form of eradication there are a large number of products, ranging from chemical substances to normal engine oil.

During the summer months mosquito eggs and larvae are found in just about any tranquil stagnant water in most parts of the world.

The object of this invention is to provide a device and method for decimating mosquito eggs, larvae and pupa that does not require electricity, batteries, chemicals or gasses, and is eco-friendly.

### THE INVENTION

According to the invention a mosquito decimating device includes a reservoir for water and a breeding chamber adapted to be moved from a first position in which it is submerged in the container for immersion in the water, and an second elevated position in which it is raised from the container for drainage of water but retention of eggs, larva and/or pupa and for subjection to ultraviolet light for decimation of the eggs, larvae and/or pupa.

In a preferred form of the invention the breeding chamber has openings that permit drainage of water but prevent egress of the eggs, larva, or pupa. A series of orifices may be provided, the orifices being covered with a mesh of correct size of opening.

In operation the breeding chamber is immersed in the water of the reservoir during the night, allowing mosquitoes to be attracted to lay their eggs. As the temperature rises during the day, the breeding chamber is elevated out of the water and the legs, larva and/or pupa are subjected to the action of the sun and are decimated.

The movement of the tray between its two positions may be effected by hand but it is preferred to provide automatic means, and more preferred to provide automatic means responsive to temperature in order to effect the movement.

A suitable mechanism responsive to solar energy may be used for the above purpose and is arranged to actuate a lever for raising or lowering the breeding chamber. The mechanism may include a solar collector. The solar collector works as a convection chamber increasing the temperature in the encapsulated area of the thermostat permitting the operation to take place at a lower ambient temperature.

The mechanism may include a thermostat or the like arrangement responsive to temperature so that the mechanism will cause the tray to move at predetermined temperatures having regard to the operation of the device.

### EMBODIMENT OF THE INVENTION

An embodiment of the invention is described below with reference to the accompanying drawings, which are side views of the device of the invention in the two positions of the breeding chamber.

In the drawings, the device includes a reservoir 10 that is filled or partly filled with water 11.

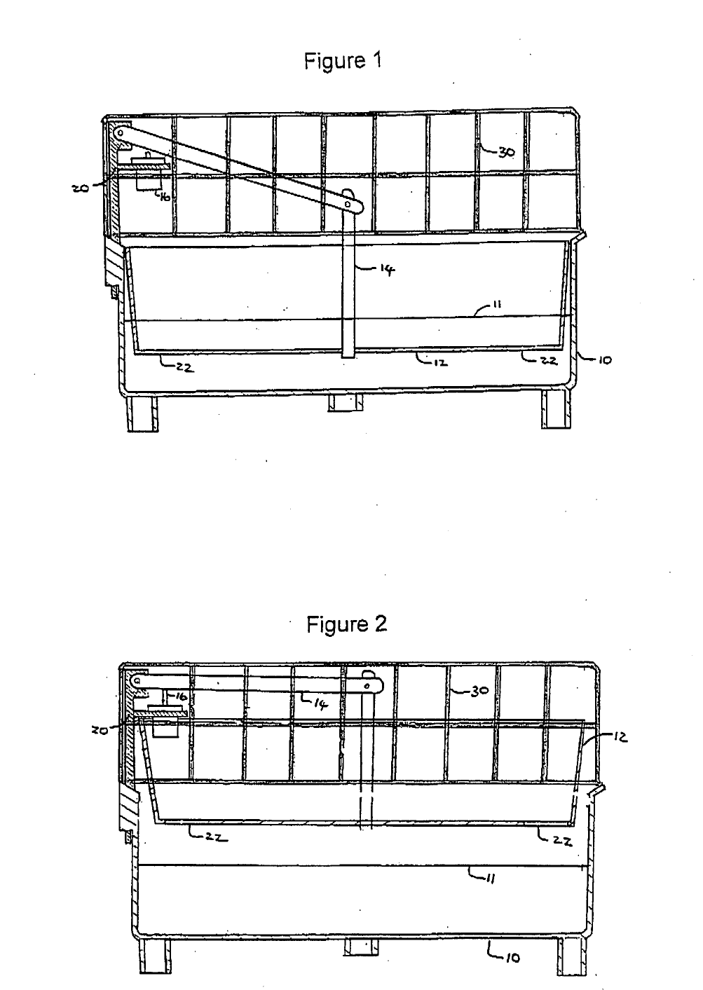

A breeding chamber 12 is supported by a lever 14 for movement between a first position as shown in FIG. 1 and an elevated position as shown in FIG. 2.

Movement of the tray between the two positions is caused by movement of the lever thanks to a device 16 that is responsive to ambient temperature. Such ambient temperature is accentuated by means of a solar collector 20.

In operation the breeding chamber is lowered at the onset of evening thereby allowing mosquitoes to lay eggs in the water. These remain during the night and may have to remain for one or more additional days in the event of inclement or cloudy weather.

In general, the operation includes the actuation of the lever during the morning of the following day to raise the breeding chamber to the position shown in FIG. 2. The water in the tray drains trough the orifices 22 which are covered with gauze to prevent egress of eggs, larva or pupa. The latter therefore become dehydrated by the action of the sun and are decimated within a few minutes.

The device may be completed with a grid 30 that serves to prevent dogs and other animals from interfering with the operation.

1. A mosquito eradication device including a reservoir for water and a breeding chamber adapted to be moved from a first position in which it is submerged in the container for immersion in the water, and an second elevated position in which it is raised from the container for drainage of water but retention of eggs, larva and/or pupa and for subjection to ultraviolet light for decimation of the eggs, larvae and/or pupa.

2. The device according to claim 1 in which the breeding chamber has openings adapted to permit drainage of water but prevention of egress of eggs, larva and pupa.

3. The device according to claim 1 in which the breeding chamber is connected to a lever responsive to temperature.

4. The device according to claim 3 in which the lever is actuated by an ambient temperature-responsive mechanism that is assisted by a solar collector.

5. The device according to claim 4 in which the mechanism includes a thermostat responsive to temperature and adapted to move the breeding chamber between its limit positions at predetermined temperatures having regard to the operation of the device.
